(19) United States
(12) Patent Application Publication
(10) Pub. No.: US 2016/0249427 A1
(43) Pub. Date: Aug. 25, 2016

(54) LED BACKLIGHT SOURCE USED IN LCD DEVCICE AND LCD DEVICE THEREFORE

(71) Applicant: SHENZHEN CHINA STAR OPTOELECTRONICS TECHNOLOGY CO., LTD., Shenzhen, Guangdong (CN)

(72) Inventors: Xinhong CHEN, Shenzhen, Guangdong (CN); Xiang YANG, Shenzhen, Guangdong (CN)

(73) Assignee: Shenzhen China Star Optoelectronics Technology Co., Ltd., Shenzhen, Guangdong (CN)

(21) Appl. No.: 14/426,381

(22) PCT Filed: Oct. 13, 2014
(86) PCT No.: PCT/CN2014/088521

§ 371 Date: Mar. 5, 2015

(30) Foreign Application Priority Data
Sep. 29, 2014 (CN) 201410515586.5

(51) Int. Cl. H05B 33/08; G09G 3/34

(52) U.S. Cl. CPC H05B 33/0851; H05B 33/0815; H05B 33/0824; G09G 3/3406; G09G 2320/0247

(57) ABSTRACT

An LED backlight source used in a LCD device is disclosed. It comprises a boost circuit, boosting the input voltage to the operating voltage of an LED string; a current control module, connecting to a negative end of the LED string for modulating the operating voltage of the LED string; a microcontroller, providing the current control module with the second square wave signal to control the current control module for achieving current modulation; a boost driver chip, providing the boost circuit with a first square wave signal to the boost circuit for achieving voltage boost function; the boost driver chip receives a feedback regulation voltage found by the microcontroller and changes a duty ratio of the first square wave signal provided by the boost circuit according to the feedback regulation voltage, for modulating the operating voltage of the LED string.

### FIELD OF THE INVENTION

The present invention relates to the LCD technical field; in particular, to a LED backlight source used in a LCD device and the LCD device.

### BACKGROUND OF THE INVENTION

As technology advances, the LCD backlight technology and equipment continue to be developed. The conventional LCD backlight device used cold cathode fluorescent lamps (CCFL) for displaying images; however, due to the disadvantages of CCFL backlight: poor color reproduction capability, low luminous efficiency, high discharge voltage, discharge characteristics at low temperature difference, long time for heating to stable gray and so on, the LED backlight source of the technical backlight source has been invented nowadays

In the traditional LED backlight sources, the LED forward current has a positive correlation with the on-voltage of the LED, i.e. the forward current is larger and the on-voltage of the LED is larger as well. In order to modulate the forward current when the LED is illuminated, the on-voltage of the LED has to be modulated quickly at the same time. However, the speed of the traditional modulation is low; the LEDs in the backlight source have a flicker problem. The LED driver chip has a malfunction about LED short protection when the problem gets worse.

### SUMMARY OF THE INVENTION

In order to solve the problem existing in the traditional art, one of the goals of the present invention is to provide a LED backlight source used in an LCD device comprising: a boost circuit, configured to boost an input voltage to an operating voltage of an LED string; a current control module, configured to connect to a negative end of the LED string for modulating the operating voltage of the LED string; a microcontroller, configured to provide the current control module with the second square wave signal to control the current control module for achieving current modulation; a boost driver chip, configured to provide the boost circuit with a first square wave signal to the boost circuit for achieving voltage boost function; the boost driver chip receives a feedback regulation voltage found by the microcontroller and changes a duty ratio of the first square wave signal provided by the boost circuit according to the feedback regulation voltage, for modulating the operating voltage of the LED string.

The other one of the goals of the present invention is to provide an LCD device comprising an LCD panel and a LED backlight source in opposite to the LCD panel, wherein the LED backlight source provides light with the LCD panel so that the LCD displays images, wherein the LED backlight source comprises: a boost circuit, configured to boost an input voltage to an operating voltage of an LED string; a current control

module, configured to connect to a negative end of the LED string for modulating the operating voltage of the LED string; a microcontroller, configured to provide the current control module with a second square wave signal to control the current control module for achieving current modulation; a boost driver chip, configured to provide the boost circuit with a first square wave signal to the boost circuit for achieving voltage boost function; the boost driver chip receives a feedback regulation voltage found by the microcontroller and changes a duty ratio of the first square wave signal provided by the boost circuit according to the feedback regulation voltage, for modulating the operating voltage of the LED string.

Further, the boost circuit comprises an inductor, a first MOS transistor, and a rectifier diode, wherein an end of the inductor is used for receiving the input voltage, the other end of the inductor connects to a positive electrode of the rectifier diode and an drain of the first MOS transistor, a negative electrode of the rectifier diode connects to a positive end of the LED string, a gate of the first MOS transistor connects to a square wave signal output end of the boost driver chip, a source of the first MOS transistor is electrically grounded.

Further, the current control module comprises a second MOS transistor and a forth resistor, wherein a gate of the second MOS transistor connects to an LED operating current control end of the microcontroller, a drain of the second MOS transistor connects to a negative end of the LED string, a source of a third MOS transistor connects to an end of the forth resistor, the other end of the forth resistor is electrically grounded.

Further, the LED backlight source further comprises a first resistor, a second resistor and a third resistor, wherein an end of the first resistor connects to a positive end of the LED string; an end of the second resistor is electrically grounded; an end of the third resistor connects to a feedback regulation voltage output end of the microcontroller; the other end of the first resistor, the other end of the second resistor and another end of the third resistor all connect to a feedback regulation voltage input end of the microcontroller.

Further, the LED string comprises a predetermined number of serially connected LEDs

In light of the LED backlight source used in the LCD device and the LCD device of the present invention, because the microcontroller can find out the corresponding feedback regulation voltage quickly based on the operating current of the LED string from the lookup table, it can modulate the operating voltage provided by the boost circuit rapidly so that the operating voltage of the LED string can be regulated quickly while the operating current of the LD string 150 is also regulated. The LEDs of the LED string avoid a flicker issue and at the same time the microcontroller 130 avoids the malfunction for protection of the short LEDs.

### BRIEF DESCRIPTION OF THE DRAWINGS

The following detailed description taken in conjunction with the above and other objects, features and advantages of the present invention will become more apparent. The figures:

FIG. 1 is a structural diagram of the LCD device according to the embodiment of the present invention;

FIG. 2 is a block diagram of the LCD backlight source used in the LCD device according to the embodiment of the present invention;

FIG. 3 is a circuit diagram of the LCD backlight source used in the LCD device according to the embodiment of the present invention.

### DETAILED DESCRIPTION OF THE PREFERRED EMBODIMENTS

In the following, the drawings will be described a preferred embodiment of the present invention reference. However, the present invention can be implemented in many different forms and should not be construed as limited to the exemplary embodiments set forth embodiment. In addition, as described in this term taking into account the features of the invention can be defined differently depending on the intent and practice of the use of the user and the operator. Therefore, it should be based on the disclosure of the specification to understand these terms. On the contrary, the present invention is intended to cover not only the exemplary embodiments, but also covers defined by the claims in the present invention, the spirit and scope of the various alternatives, modifications, equivalents and other embodiments.

FIG. 1 is the structural diagram of the LCD device according to the embodiment of the present invention.

Refer to FIG. 1. Based on the embodiment of the present invention, the LCD device comprises a LCD panel 200 and a LED backlight source 100 which are in opposite to each other, where the LED backlight source 100 provides light source for the LCD panel 200 so that the LCD panel 200 displays the images.

In the following description, the LED backlight source 100 is narrated based on the embodiment of the present invention.

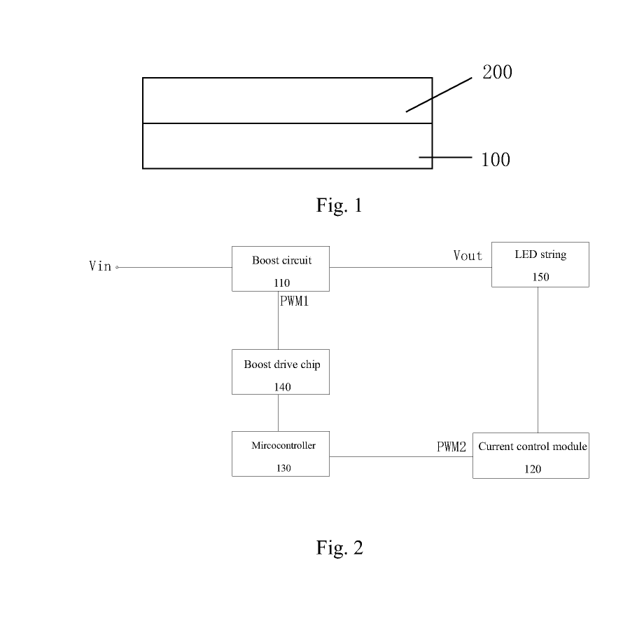

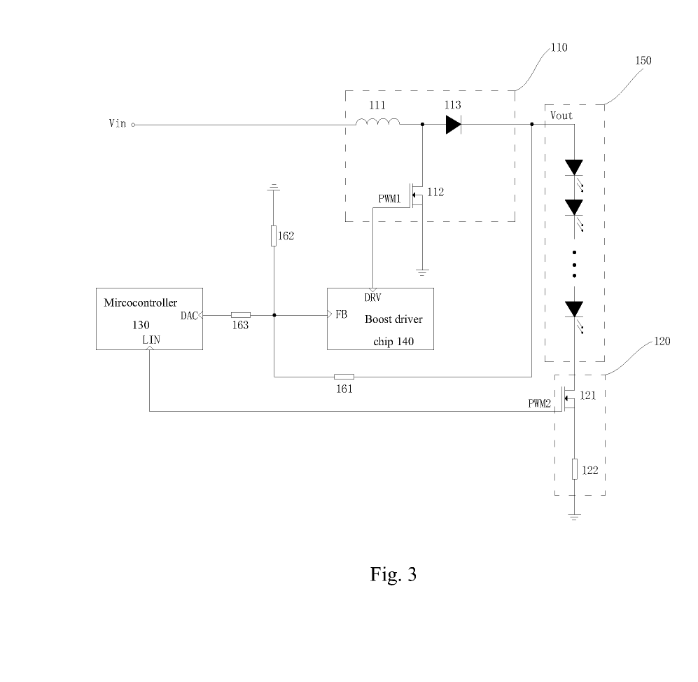

FIG. 2 is the block diagram of the LED backlight source used in the LCD device based on the embodiment of the present invention; FIG. 3 is the circuit diagram of the LED backlight source used in LCD device based on the embodiment of the present invention.

Please refer to FIG. 2 and FIG. 3. The LED backlight source based on the present invention comprises: a boost circuit 110, a current control module 120, a micro control unit (called MCU for short) 130, a boost driver chip (IC) 140 and a LED string 150.

Specially, the boost circuit 110 can be an inductive boost circuit used in boosting an inputting voltage Vᵢₙ into an operating voltage for the LED string 150. The boost circuit 110 comprises an inductor 111, a first MOS transistor 112, and a rectifier diode 113. In the present embodiment, one end of the inductor 111 is used for receiving the input voltage Vin and the other end of the inductor 111 connects to the positive electrode of the rectifier diode 113 and a drain of the first MOS transistor 112. The negative electrode of the rectifier diode 113 connects to the positive end of the LED string 150. The gate of the first MOS transistor 112 connects to the square wave signal output end (DRV) of the boost driver chip 140. The source of the first MOS transistor is electrically grounded. It should be understood that the boost circuit is not limited in the circuit configuration of the boost circuit 10 in FIG. 3. It can be another suitable circuit configuration of the boost circuit.

In the boost circuit 110, the inductor 11 is an energy conversion device which is between the electricity and magnetic field. When the gate of the first MOS transistor 112 receives the high-level signal of the first square wave signal PWM1 provided by the square wave signal wave output end (DRV) of the boost driver chip 140, the inductor 111 transforms the magnetic field into the electricity and saves it. Then, the electricity is superposed with the input voltage Vin, the rectifier diode 113 filters the signal and a DC voltage is obtained after the gate of the first MOS transistor 112 receives the high-level signal of the first square wave signal PWM1 provided by the square wave signal wave output end (DRV) of the boost driver chip 140. Because the DC voltage is formed by the electricity conversed from the magnetic field of the inductor 111 superposing with the input voltage Vin, the DC voltage is higher than the input voltage Vin.

The LED string 150 is used as a backlight source of the LCD device, where the LED string 150 comprises a predetermined number of serially connected LEDs. The LED string 150 receives the operating voltage which it requires for work normally. The LED amount N (N is an integer and larger than zero) of the LED string is made sure by the following rule:

N×Vd≦Vₒᵤₜ,

Where, V_{d} is a voltage for normal emission of each LED, and Vₒᵤₜ is the operating voltage received from the boost circuit and required for work normally.

For example, when V_{d} is 6.5V and Vout=48V, N≦7.

The current control module 120 connects to the negative end of the LED string 150 for modulating the operating current of the LED string. The current control module 120 comprises the second MOS transistor 121 and the forth resistor 122, where the gate of the second MOS transistor 121 connects to the LED operating current control end (LIN) of the microcontroller 130 and the drain of the second MOS transistor 121 connects to one end of the forth resistor 122. The other end of the forth resistor 122 is electrically grounded.

The gate of the third MOS transistor 121 receives the second square wave signal PWM2 provided by the LED operating control end (LIN) of the microcontroller 130. The microcontroller 130 enlarges or reduces the operating current of the LED string 150 via modulating the duty ratio of the second square wave signal PWM2. Based on the embodiment of the present invention, the operating current of the LED string 150 is usually stable. The microcontroller finds out the feedback regulation voltage from its lookup table based on the operating current of the LED string 150. The lookup table is set in the microcontroller 130. The feedback regulation voltage output end (DAC) of the microcontroller 130 connects to the feedback regulation voltage input end (FB) of the boost driver chip 140 through the third resistor 163. The boost driver chip 140 receives the feedback modulating voltage based on the feedback regulation voltage input end (FB) and changes the duty ratio of the first square wave signal PWM1 provided by the square wave output end (DRV) and then modulates the operating voltage provided for the LED string 150 by the boost circuit 110.

Otherwise, one end of the first resistor 161 connects to the positive end of the LED string 150. One end of the second resistor 162 is electrically grounded. The other ends of the first resistor 161 and the second resistor 162 both connect to the feedback regulation voltage input end (FB) of the boost drive chip 140.

In the following description, the relation between the operating current of the LED string 150 and the feedback regulation voltage of the feedback regulation voltage output end (DAC) of the microcontroller is narrated.

In the present embodiment, the relation between the operating current of the LED string 150 and the feedback regulation voltage of the feedback regulation voltage output end (DAC) of the microcontroller can be indicated in the following formula (1)

$${V}_{LED} = {V}_{FB} \times ( \frac{{R}_{1}}{{R}_{3}} + \frac{{R}_{1}}{{R}_{2}} + 1 ) - {V}_{DAC} \times \frac{{R}_{1}}{{R}_{3}} \qquad [ Formula 1 ]$$

Where, VLED represents the operating voltage of the LED string 150, VDAC represents the feedback regulation voltage outputted by the feedback regulation voltage output end (DAC) of the microcontroller 130. VFB represents the feedback regulation voltage received from the feedback regulation voltage input end (FB) of the boost driver chip 140, R1 represents the resistor value of the first resistor 161, R2 represents the resistor value of the second resistor 162 and R3 represents the resistor value of the third resistor 163.

Because the operating current of the LED string 150 is proportional to the operating voltage of the LED string 150, and the operating voltage of the LED string 150 is inversely proportional to the feedback regulation voltage of the feedback regulation voltage output end (DAC) of the microcontroller, the operating current of the LED string 150 is inversely proportional to the feedback regulation voltage of the feedback regulation voltage output end (DAC) of the microcontroller. Therefore, based on the inverse proportional relation, the lookup table of the operating current of the LED string 150 and the feedback regulation voltage of the feedback regulation voltage output end (DAC) of the microcontroller, can be set up in the microcontroller 130. In the lookup table, a current value of the operating current of the LED string 150 corresponds to the feedback regulation voltage of the feedback regulation voltage output end (DAC) of the microcontroller.

In summary, because the microcontroller 130 can find out the corresponding feedback regulation voltage quickly based on the operating current of the LED string from the lookup table, it can modulate the operating voltage of the boost circuit 110 and provide it for the LED string rapidly so that the operating voltage of the LED string 150 can be regulated quickly while the operating current of the LED string 150 is also regulated. The LEDs of the LED string avoid a flicker issue and at the same time the microcontroller 130 avoids the malfunction for protection of the short LEDs.

Although certain exemplary embodiments with reference to the present invention is shown and described the present invention, those skilled in the art should be appreciated that without departing from the spirit and scope of the appended claims and their equivalents of the present invention Next, in form and details may present invention may be variously changed.

What is claimed is:

1. An LED backlight source for a LCD device, comprising:
a boost circuit, configured to boost an input voltage to an operating voltage of an LED string;
a current control module, configured to connect to a negative end of the LED string for modulating the operating voltage of the LED string;
a microcontroller, configured to provide the current control module with the second square wave signal to control the current control module for achieving current modulation;
a boost driver chip, configured to provide the boost circuit with a first square wave signal to the boost circuit for achieving voltage boost function;
the boost driver chip receives a feedback regulation voltage found by the microcontroller and changes a duty ratio of the first square wave signal provided by the boost circuit based on the feedback regulation voltage, for modulating the operating voltage of the LED string.

2. The LED backlight source as claimed in claim 1, wherein the boost circuit comprises an inductor, a first MOS transistor, and a rectifier diode, wherein an end of the inductor is used for receiving the input voltage; another end of the inductor connects to a positive electrode of the rectifier diode and an drain of the first MOS transistor; a negative electrode of the rectifier diode connects to a positive end of the LED string, a gate of the first MOS transistor connects to a square wave signal output end of the boost driver chip; and a source of the first MOS transistor is electrically grounded.

3. The LED backlight source as claimed in claim 1, wherein the current control module comprises a second MOS transistor and a forth resistor, wherein a gate of the second MOS transistor connects to an LED operating current control end of the microcontroller; a drain of the second MOS transistor connects to a negative end of the LED string; a source of a third MOS transistor connects to an end of the forth resistor; and another end of the forth resistor is electrically grounded.

4. The LED backlight source as claimed in claim 1, wherein the LED backlight source further comprises a first resistor, a second resistor and a third resistor, wherein an end of the first resistor connects to a positive end of the LED string; an end of the second resistor is electrically grounded; an end of the third resistor connects to a feedback regulation voltage output end of the microcontroller; another end of the first resistor; another end of the second resistor and another end of the third resistor all connect to a feedback regulation voltage input end of the microcontroller.

5. The LED backlight source as claimed in claim 1, wherein the LED string comprises a predetermined number of serially connected LEDs.

6. An LCD device, comprising a LCD panel and a LED backlight source in opposite to the LCD panel, wherein the LED backlight source provides light with the LCD panel so that the LCD panel displays images, wherein the LED backlight source comprises:
a boost circuit, configured to boost an input voltage to an operating voltage of an LED string;
a current control module, configured to connect to a negative end of the LED string for modulating the operating voltage of the LED string;
a microcontroller, configured to provide the current control module with a second square wave signal to control the current control module for achieving current modulation;
a boost driver chip, configured to provide the boos circuit with a first square wave signal to the boost circuit for achieving voltage boost function; and
the boost driver chip receives a feedback regulation voltage found by the microcontroller and changes a duty ratio of the first square wave signal provided by the boost circuit according to the feedback regulation voltage, for modulating the operating voltage of the LED string.

7. The LCD device as claimed in claim 6, wherein the boost circuit comprises an inductor, a first MOS transistor, and a rectifier diode, wherein an end of the inductor is used for receiving the inputting voltage; another end of the inductor connects to a positive electrode of the rectifier diode and an drain of the first MOS transistor; a negative electrode of the rectifier diode connects to a positive end of the LED string; a gate of the first MOS transistor connects to a square wave signal output end of the boost driver chip; and a source of the first MOS transistor is electrically grounded.

8. The LCD device as claimed in claim 6, wherein the current control module comprises a second MOS transistor and a forth resistor, wherein a gate of the second MOS transistor connects to a LED operating current control end of the microcontroller; a drain of the second MOS transistor connects to a negative end of the LED string; and a source of a third MOS transistor connects to an end of the forth resistor, another end of the forth resistor is electrically grounded.

9. The LCD device as claimed in claim 6, wherein the LED backlight source further comprises a first resistor, a second resistor and a third resistor, wherein an end of the first resistor connects to a positive end of the LED string; an end of the second resistor is electrically grounded; an end of the third resistor connects to a feedback regulation voltage output end of the microcontroller; another end of the first resistor; and another end of the second resistor and another end of the third resistor al connect to a feedback regulation voltage input end of the microcontroller.

10. The LCD device as claimed in claim 6, wherein the LED string comprises a predetermined number of serially connected LEDs.
